(19) United States
(12) Patent Application Publication
(10) Pub. No.: US 2009/0235457 A1
(43) Pub. Date: Sep. 24, 2009

(54) Medical Table Foot and Leg Support System

(76) Inventor: William J. Harvey, Honeoye, NY (US)

Correspondence Address: Woods Oviatt Gilman LLP, 700 Crossroads Bldg, 2 State St., Rochester, NY, 14614, US

(21) Appl. No.: 12/053,818

(22) Filed: Mar. 24, 2008

(51) Int. Cl. A61G 5/12

(52) U.S. Cl. 5/624

(57) ABSTRACT

A patient foot and leg support system which may be easily and quickly attached to and replace exam-type supports on a standard GYN exam table. The boot-type supports of the present invention are configured and positioned to provide maximum patient comfort over the prolonged periods demanding of certain medical procedures which would not otherwise be possible using the exam-type foot and leg supports typically used with GYN exam tables. As such, a doctor may easily convert their existing GYN exam table into a procedure table within their office as desired.

### BACKGROUND OF THE INVENTION

The present invention relates to medical exam tables, and more particularly relates to a foot and leg support system for removable attachment to an exam table of the type typically used for performing gynecology exams. The system allows a doctor to easily replace the conventional stirrup type foot and leg supports with boot-type foot and leg supports which allows a much more comfortable and prolonged support for the patient's feet and legs. As such, a doctor may easily and quickly convert their office exam table into a procedure table allowing more extensive medical procedures to be performed on the patient due to the prolonged support of the patient's feet and legs.

Exam tables with foot and leg supports are commonly used in a medical office for performing obstetric/gynecological or other examinations of a patient. Foot supports extend from the end of the table upon which the patient supports each foot with the legs in an abduction position which allows the obstetrician/gynecologist to perform the exam. There are several different types of leg supports, the most common being the so-called “stirrup” leg support wherein a heel is placed upon a respective heel support mounted to the end of a bar extending from the end of the table. Another type is the so-called “knee crutch” type which supports the leg under the knee. This type of support is not favored by many doctors or patients since it does not secure the patient's feet which simply hang free.

Yet another type of leg support is the so-called “boot” type which supports the full foot and extends up the back of the calf to a point between the ankle and knee. The boot-type support is considered more supportive and secure, allowing a patient to be supported over an extended period of time and are thus typically found on surgical operating room (“OR”) tables which are much more expensive (e.g., about $50,000.00) than exam tables (e.g., about $800.00 to about $7,000.00).

Medical office exams requiring patient leg support typically last about 5 minutes and the stirrup type of foot rest is the standard exam-type support system used in most doctor offices. For procedures lasting longer than about 5 minutes, the Inee-crutch type leg support is typically used, however, the knee-crutch is not designed to keep a patient comfortable much longer than about 20 minutes and furthermore do not stabilize the legs to a significant degree. For example, neither the stirrup nor knee-crutch types of leg supports would secure a patient's legs to the degree necessary to perform an involved surgical procedure such as a vasectomy or labiaplasty, for example. Furthermore, as stated above, many patient's report feeling undignified in the knee-crutch type of support since their legs are allowed to “dangle” from the support making them feel physically (and thus also mentally) vulnerable and insecure. It will thus be realized that exam tables having stirrup or knee-crutch type leg supports are not suitable for stabilizing and supporting a patient's legs during a surgical or other medical procedure lasting more than about 5 to 20 minutes.

Rising medical costs have resulted in the migration of many medical procedures from the hospital to an ambulatory (outpatient) surgical center or the doctor's personal office. Unfortunately, the exam tables found in most doctor offices are not designed to perform prolonged surgical procedures for the reasons explained above. Due to the relatively high cost of the OR tables, doctors are reluctant to purchase these tables for their offices. There therefore exists a need for a “procedure type” foot and leg support system which can be easily fitted to an existing exam table, allowing the doctor to quickly convert his or her exam table into a procedure table.

### SUMMARY OF THE INVENTION

The present invention addresses the above need by providing a patient foot and leg support system which converts a typical gynecological examination table into a procedure table. The term “gynecological” or “GYN” is used herein for the sake of convenience only, it being understood that the medical tables and invention described herein may be used for medical procedures other than strictly gynecology or obstetrics (e.g., proctology, urology, and various genitalia procedures, etc.).

The patient foot and leg support system of the present invention includes a pair of foot and leg support assemblies with each assembly including a boot-type support mounted to a first end of a support bar. Should the GYN exam table have stirrup (or other) type of leg supports already installed, these are first removed in accordance with the stirrup manufacturer's instruction manual. In a typical GYN exam table, the stirrup support bars extend into the table and may be alternately extended for use, and then retracted into the table to a storage position. A screw is attached at the end of each support bar inside the table and acts as a stop to prevent the bar from fully separating from the table. A bracket is provided at each support bar table entry point which allows the support bar to be selectively pivoted laterally which allows the doctor to position the patient's leg at the desired angle for examination.

As stated above, the present invention provides a pair of boot-type support bars which may replace existing stirrup or other exam-type of foot and leg supports on a GYN exam table. The doctor or assistant first accesses the ends of the existing support bars inside the table and removes the screws which prevent the bars from separating from the table as explained above. This allows the existing support bars to be removed from the table. The doctor or assistant then inserts the support bars of the present invention into the spaces previously occupied by the existing support bars. The inventive support bars are secured to the table using a cotter pin or the like which does not require a tool to attach and remove from the respective support bar. The cotter pins may then also replace the screws when it is desired to switch the support bars back to the stirrup or other exam-type support bars. As such, the doctor or assistant may quickly and easily switch between exam-type support bars and the present procedure-type support bars.

The boot-type foot and leg supports of the present invention are attached to the ends of the support bars extending from the table. The boot is a contoured piece and open at the front. A removable liner is positioned on the inside surface of the boot and on which the patient rests their foot. The boot includes a rear wall which extends behind the calf to provide additional support to the patient's leg. Straps are provided to secure the foot in the boot.

The boot is mounted to a metal plate which in turn is mounted to and extends along the end of the second segment of the support bar. The end of the second support bar extends at an angle with respect to the first end of the first support bar, the opposite end of which extends into and connects to the table. In a preferred embodiment, the metal plate is tilted at an angle with respect to the axis of the second support bar so as to position the patient's legs in an abduction position for the medical procedure.

### BRIEF DESCRIPTION OF THE DRAWINGS

FIG. 1 is a perspective view of an embodiment of the invention installed on an examination table;

FIG. 2 is a fragmented top plan view of an embodiment of the invention showing one method of attaching the support bars to the table;

FIG. 3 is a fragmented perspective view of the right leg support of FIG. 1;

FIG. 4 is a fragmented front elevational view of the left boot support plate of FIG. 1;

FIG. 5 is a front elevational view of a lateral securing bar;

FIG. 6 is a fragmented top plan view showing the securing bar of FIG. 5 attached to the support bars of the present invention; and

FIG. 7 is a fragmented perspective view showing an alternate embodiment of the support bar.

### DETAILED DESCRIPTION

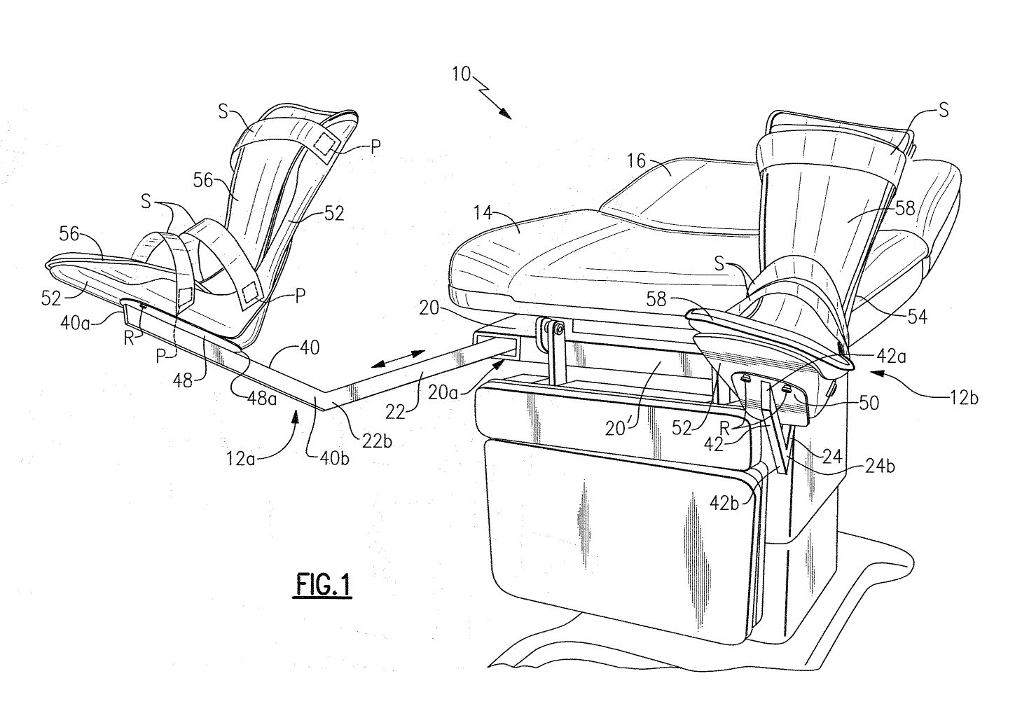

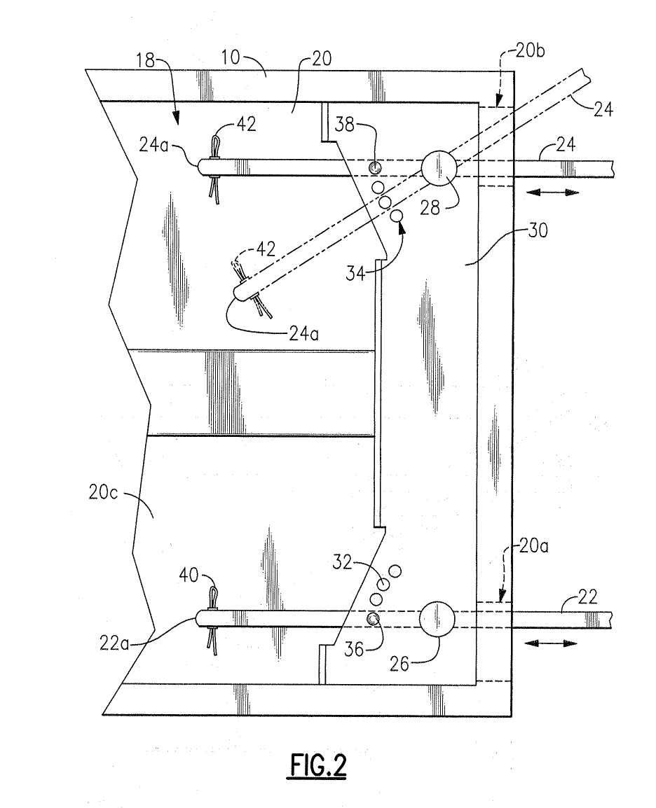

Referring now to the drawing, there is seen in FIG. 1 a GYN exam table 10 to which an embodiment of the inventive foot and leg support system 12 has been removably attached. Table 10 is a typical prior art GYN exam table used in a doctor's office to perform routine gynecological exams. In this particular model of exam table, the bottom half 14 of the table pad 16 pivots upwardly to expose and provide access to the inside cavity 18 of the table platform 20 as seen in FIG. 2. Other exam table models may provide inside access through apertures formed in the sides of the table, for example.

As explained above, should the doctor desire to change his/her existing office exam table into a procedure table, the existing stirrup or other exam-type of support bars are first removed from the table by accessing the inside cavity 18 thereof and removing the screws or other securing elements from the ends of the support bars (this step not shown). The exam-type support bars may then be withdrawn and separated from the table platform 20 through the platform apertures 20a, 20b positioned adjacent either side of the platform edge 20′.

Once the existing stirrup or other exam-type support bars are removed, the boot-type support bars 12 of the present invention are attached to table 10 by inserting the first end 22a, 24a of support bar segment 22, 24 into platform apertures 20a, 20b, respectively. Another set of smaller apertures 26, 28 are provided within area 18 into which the respective support bars 22, 24 extend and may pivot as seen best in FIG. 2. Support bars 22, 24 are pivotable to allow the doctor to position the bars 22, 24 at a desired angular position with respect to the table 10 (see, e.g., bar 24 as shown in an alternate angular position in dotted outline in FIG. 2). To secure the bar 22, 24 at the desired angle, bracket (not shown) having a boss 36, 38 may be provided through which each support bar 22, 24 extends, respectively, such that the brackets pivot together with their respective support bar 22, 24. The boss 36, 38 is sized to extend into one of several holes 32, 34 arranged in arcuate fashion in a respective bracket or plate 30 spaced above the platform floor 20c. Although a boss and array of holes are shown, it is understood there are many other ways of allowing selective pivotable movement to the support bars as is understood by those skilled in the art. Since the majority of the weight of the bars are at the ends extending from the table, the support bars 22, 24 will be pressed upwardly against plate 30 and thereby secure the boss within a respective hole. When it is desired to change the pivotal position of the support bar, the doctor simply lifts the extended end of the support bar which releases the boss from its respective hole and pivots the bar to the selected angular position.

A manually operable securing element such as a lynch pin or cotter pin 40, 42, for example, may be attached through a respective hole formed adjacent support bar first ends 22a, 24a to prevent accidental separation of support bars 22, 24 from table 10. Cotter pins 40,42 are longer than the diameter of apertures 26, 28 such that bars 22, 24 cannot be withdrawn therefrom without first removing cotter pins 40,42. Since the cotter pins do not require any special tools for attachment or removal, the doctor or assistant may easily and quickly attach and remove the pins as desired when switching between the present inventive boot-type foot and leg support system and the stirrup or other exam-type foot and leg supports. It will thus be appreciated that the cotter pins or other manually operable securing element may also replace the screws typically used on exam table support bars as explained above. As such, the doctor or assistant may quickly and easily switch between the exam-type supports and the boot-type supports as necessary for his/her practice.

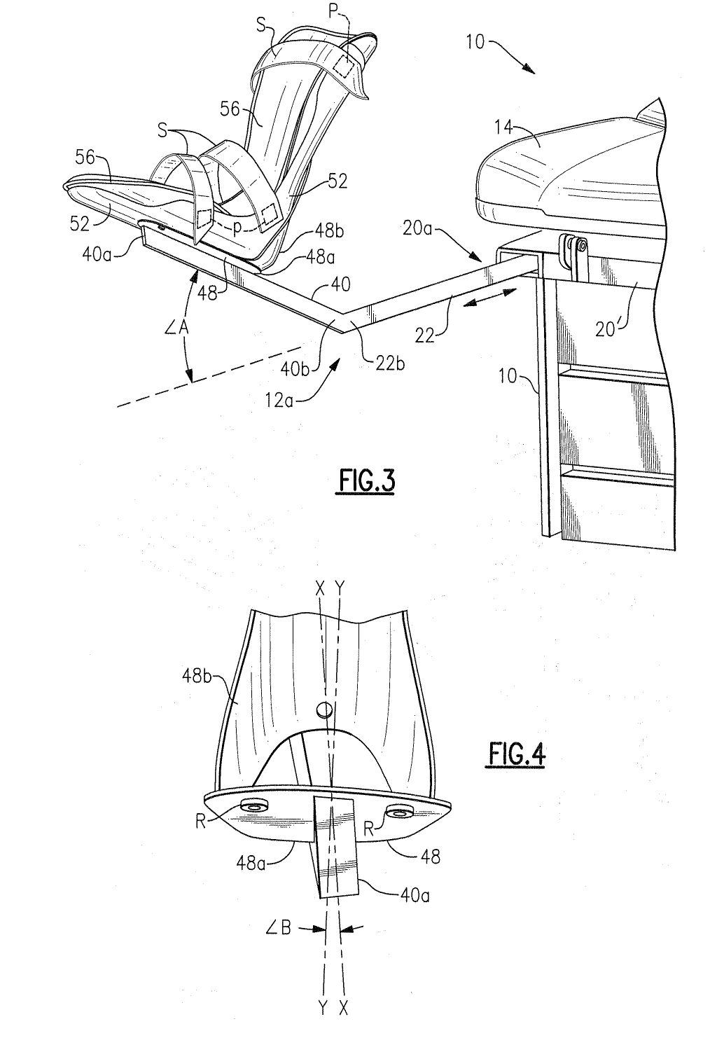

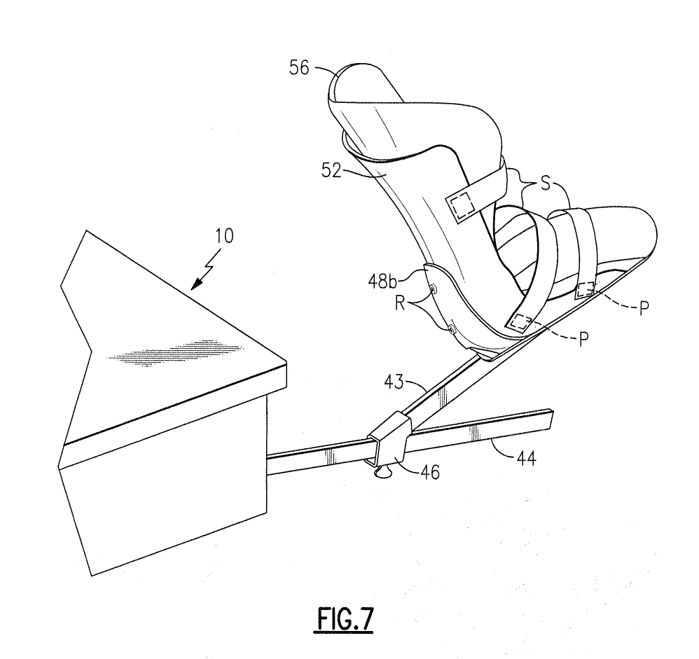

Referring now also to FIGS. 3 and 4, boot-type supports 12a, 12b each include a second segment of support bar 40, 42 attached at first ends 40b, 42b thereof to second ends 22b, 24b of the first support bar 22, 24, respectively. Second support bars 40, 42 extend upwardly at a desired angle “A” with respect to respective first support bar 22, 24. Angle A may be between about 20 and about 45 degrees, is more preferably between about 30 and 40 degrees, and is most preferably about 35 degrees. Second support bar 40, 42 may be integrally formed with respective first support bar 22, 24 as seen in FIGS. 1 and 3, or formed separately as seen in FIG. 7. In the embodiment of FIG. 7, second support bar 43 is slidable along first support bar 44 and may be secured in a selected position therealong by clamp 46. Clamp 46 may include nylon glides, for example, (not shown) through which bar 44 extends to facilitate the sliding motion of clamp 46 therealong. This embodiment thus allows the doctor to position the boot at a selected distance from the table which, in turn, bends the patient's knees at the desired angle.

A boot support plate 48, 50 is welded or otherwise firmly secured in traversing relation to second support bar 40, 42 adjacent the terminal ends 40a, 42a thereof, respectively. Plate 48, 50 each further include a rear wall 48b, 50b (rear wall 50b not shown) extending upwardly from the rear edge 48a, 50a thereof, respectively. Each plate 48, 50 may further be tilted outwardly (away from each other and table 10) at an angle “B” (FIG. 4) defined between a vertical axis y-y of the plate rear wall 48b, 50b and a vertical axis x-x of the support bar end 40a. Tilting plate 48, 50 positions the patient's legs in a more desirable abduction position. Angle B may be between about 0 to about 15 degrees, is more preferably between about 5 and 12 degrees, and is most preferably about 10 degrees. It is also noted that although plate 48 is shown traversing support bar 40 in generally parallel relation thereto, plate 48 may be aligned in non-parallel relation thereto depending on the desired patient foot and leg placement. A support boot 52, 54 is secured to a respective plate 48, 50, via rivets R or other suitable means (see also FIG. 7). Each boot 52, 54 is preferably open at the front to allow the patient to easily place their foot within a respective boot. The boot has a bottom and upwardly extending calf support to provide a comfortable and secure support for the patient's foot. In the preferred embodiment, the boot is generically shaped such that the same boot may fit either the right or left foot. A liner 56, 58 may be provided which is removably attached to the inside surface of the boot 52, 54 to provide further cushioning and support to the patient's foot and leg. The liner may be made of a disposable and/or washable material such that it may be easily replaced as needed. The liner may have multiple layers with a foam core layer. The inner surface of the boot may include a VELCRO patch (not shown) or the like to allow the removable yet secure attachment of the liner thereto. For example, the VELCRO patch may be the hook side of VELCRO and the bottom layer of the liner may be a loop-type of material that will removably stick to the hook side of the VELCRO. To further secure the patient's foot within the boot, one or more straps S may be provided which wrap over the patient's foot and leg to secure it to the respective boot. The straps S may be cut as needed from a roll of VELFOAM, for example, and secured to the boot 52, 54 by VELCRO hook patches P applied to the boot such that the straps S are completely separable from the boot 52, 54 and may therefore be easily replaced as necessary.

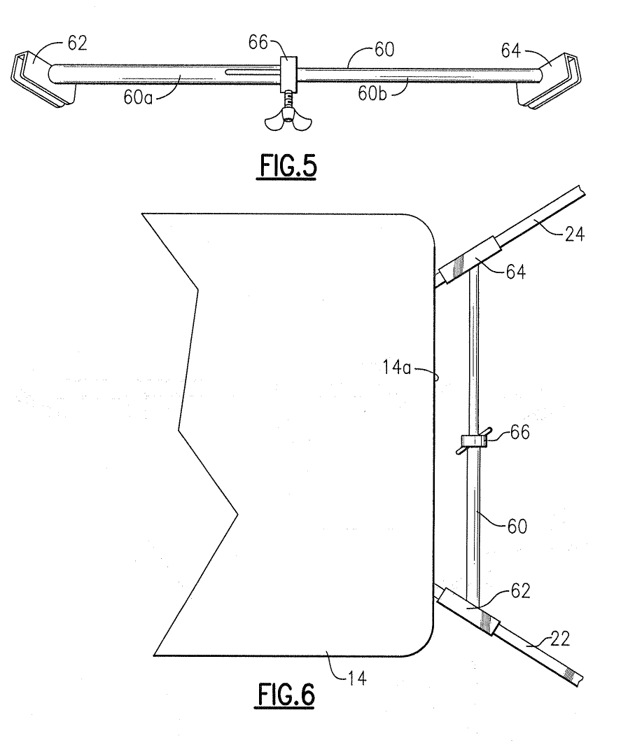

Referring now to FIGS. 5 and 6, an optional brace bar 60 may be provided to more firmly secure support bars 22, 24 in their set position for the medical procedure. Brace bar 60 extends between and removably attaches to support bars 22, 24 via U-shaped brackets 62, 64 although other suitable removable attachment mechanisms may be used as desired. Brace bar 60 may be constructed as a single piece, but is more preferably constructed as a pair of telescoping segments 60a, 60b that are adjustable in length to accommodate the varied angular positions at which the support bars 22, 24 may be set. As such, the brackets 62, 64 may be slid along bars 22, 24 with the simultaneous telescoping of bar poles 60a, 60b until the desired placement of brace bar 60 is reached. Once in the desired position (e.g., close to the table edge 14a), the doctor simply secures the poles 60a, 60b in place via clamp 66.

As explained above, the invention thus provides a patient foot and leg support system which may be easily and quickly attached to and replace exam-type supports on a standard GYN exam table. The boot-type supports of the present invention are configured and positioned to provide maximum patient comfort over the prolonged periods demanding of certain medical procedures which would not otherwise be possible using the exam-type foot and leg supports typically used with GYN exam tables. As such, a doctor may easily convert their existing GYN exam table into a procedure table within their office as desired.

What is claimed is:

1. A foot and leg support assembly for converting a medical exam table into a procedure table, the medical exam table having first and second apertures leading to an interior space within said table, said assembly comprising:
a) a first support bar having first and second ends;
b) a second support bar having first and second ends, said second bar second end attached to said first support bar second end at an angle A;
c) a boot plate secured to said first end of said second bar, said boot plate positioned at an angle B relative to a vertical axis of said first end of said second bar;
d) a support boot secured to said boot plate, said support boot configured for placement of a patient foot therein;
e) one or more straps removably attachable to said support boot for securing a patient's foot in said support boot;
f) a manually operable securing element removably attachable to said first support bar first end;
whereby said assembly is removably attachable to said exam table by passing said first support bar first end through a respective said aperture and then attaching said securing element to said first support first end, said securing element configured to act as a stop to prevent unintentional withdrawal and separation of said first support bar from the exam table.

2. The assembly of claim 1 wherein angle B is between about 0 and about 15 degrees.

3. The assembly of claim 1 wherein angle B is between about 5 and about 12 degrees.

4. The assembly of claim 1 wherein angle B is about 10 degrees.

5. The assembly of claim 1, and further comprising a liner for removable attachment to said support boot.

6. The assembly of claim 1, wherein said first support bar is pivotable with respect to said table.

7. The assembly of claim 1 wherein said second support bar is formed integrally with said second support bar.

8. The assembly of claim 1 wherein said second support bar is separable from said first support bar, said second support bar being selectively movable along said first support bar.

9. The assembly of claim 8, and further comprising a clamp for securing said second support bar in a selected fixed position with respect to said first support bar.

10. The assembly of claim 1, and further comprising a brace bar for removably attaching to and between a pair of said assemblies attached to an exam table.

11. The assembly of claim 10 wherein said brace bar comprises a pair of telescoping segments allowing said brace bar to be selectively lengthened and shortened.

12. The assembly of claim 11 and further comprising first and second brackets located at opposite ends of said brace bar, respectively, said first and second brackets being slidable along said first support bars of each assembly, respectively.

13. The assembly of claim 1, wherein said angle A is between about 0 and about 45 degrees.

14. The assembly of claim 1, wherein said angle A is between about 30 and about 40 degrees.

15. The assembly of claim 1, wherein said angle A is about 35 degrees.

16. The assembly of claim 1 wherein said manually operable securing element is a lynch pin.

17. The assembly of claim 1 wherein said manually operable securing element is a cotter pin.

18. A method of converting a medical exam table having exam-type foot and leg supports into a procedure table, the medical exam table having first and second apertures leading to an interior space within said table, said method comprising the steps of:
a) removing the exam-type foot and leg supports from the exam table;
b) providing a first support bar having first and second ends;
c) providing a second support bar having first and second ends, said second bar second end attached to said first support bar second end at an angle A;
d) providing a boot plate secured to said first end of said second bar, said boot plate positioned at an angle B relative to a vertical axis of said first end of said second bar;
e) providing a support boot secured to said boot plate, said support boot configured for placement of a patient foot therein;
f) providing one or more straps removably attachable to said support boot for securing a patient's foot in said support boot;
g) providing a manually operable securing element removably attachable to said first support bar first end;
h) passing said first support bar first end through a respective said aperture; and
i) attaching said securing element to said first support first end, said securing element configured to act as a stop to prevent unintentional withdrawal and separation of said first support bar from the exam table.

19. The assembly of claim 18, wherein angle B is between about 0 and about 15 degrees.

20. The assembly of claim 18, wherein angle B is between about 5 and about 12 degrees.

21. The assembly of claim 18, wherein angle B is about 10 degrees.

22. The assembly of claim 18, and further comprising a liner for removable attachment to said support boot.

23. The assembly of claim 18, wherein said first support bar is pivotable with respect to said table.

24. The assembly of claim 18 wherein said second support bar is formed integrally with said second support bar.

25. The assembly of claim 18 wherein said second support bar is separable from said first support bar, said second support bar being selectively movable along said first support bar.

26. The assembly of claim 25, and further comprising a clamp for securing said second support bar in a selected fixed position with respect to said first support bar.

27. The assembly of claim 18, and further comprising a brace bar for removably attaching to and between a pair of said assemblies attached to an exam table.

28. The assembly of claim 27 wherein said brace bar comprises a pair of telescoping segments allowing said brace bar to be selectively lengthened and shortened.

29. The assembly of claim 28 and further comprising first and second brackets located at opposite ends of said brace bar, respectively, said first and second brackets being slidable along said first support bars of each assembly, respectively.

30. The assembly of claim 18, wherein said angle A is between about 0 and about 45 degrees.

31. The assembly of claim 18, wherein said angle A is between about 30 and about 40 degrees.

32. The assembly of claim 18, wherein said angle A is about 35 degrees.

33. A foot and leg support assembly for a medical exam table into a procedure table, said assembly comprising:
a) a first support bar having first and second ends;
b) a second support bar having first and second ends, said second bar second end attached to said first support bar second end at an angle A;
c) a boot plate secured to said first end of said second bar, said boot plate positioned at an angle B relative to a vertical axis of said first end of said second bar; and
d) a support boot secured to said boot plate, said support boot configured for placement of a patient foot therein.
